(19) United States
(12) Patent Application Publication
(10) Pub. No.: US 2006/0077882 A1
(43) Pub. Date: Apr. 13, 2006

(54) Optical recording medium, recording/reproducing method and recording/reproducing apparatus

(75) Inventors: Kyung-geun Lee, Seongnam-si (KR); Wook-yeon Hwang, Yangpyeong-gun (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/228,308

(22) Filed: Sep. 19, 2005

(30) Foreign Application Priority Data
Oct. 8, 2004 (KR) 2004-80583

(51) Int. Cl. G11B 7/24; G11B 5/09

(52) U.S. Cl. 369/275.1; 369/275.3; 369/47.5

(57) ABSTRACT

An optical recording medium, a recording and/or reproducing method and a recording and/or reproducing apparatus by which data can be quickly recorded according to an optimum recording and/or reproducing condition. A reference signal area is disposed in each of the recording layers in order to record a predetermined reference signal at an optimum recording condition. A reference signal information area includes reference signal indicator information which indicates information on each recording layer in which the reference signal is recorded. In a case of a multi-layered information storage medium, by recording a reference signal only in a layer used by an initial drive data can be written in a minimum time when the disk is first used. By making a mark on a recording layer in which a reference signal is recorded, management of the reference signal is efficiently performed.

### CROSS-REFERENCE TO RELATED PATENT APPLICATION

This application claims the benefit of Korean Patent Application No. 2004-80583, filed on Oct. 8, 2004, in the Korean Intellectual Property Office, the disclosure of which is incorporated herein by reference.

### BACKGROUND OF THE INVENTION

1. Field of the Invention

An aspect of the present invention relates to an optical recording medium, and a method and apparatus for recording data on and/or reproducing data from an optical recording medium.

2. Description of the Related Art

Optical disks are widely employed as information recording media in optical pickup apparatuses recording and/or reproducing information contactlessly. According to the information recording capacity, optical discs may be classified into compact disks (CDs) and digital versatile disks (DVDs). Optical disks capable of recording, deleting, and reproducing data include 650 MB CD-Rs, CD-RWs, 4.7 GB DVD+RWs and so on, and reproduction dedicated optical disks include 650 MB CDs, 4.7 GB DVD-ROMs and so on. Furthermore, the development of high-density (HD) DVDs or Blue-ray disks (BD) with a recording capacity over 15 GB have been completed and higher capacity disks, for example, super-resolution near-field structure (super-RENS) disks or other disks using a near field structure and hologram disks are also under development.

An optical recording and/or reproducing apparatus which records data on and/or reproduces data from an optical disk such as a CD or DVD irradiates a light beam of a relatively higher energy capable of changing the physical characteristic of an information recording layer to record information on the optical disk, and uses a light beam of a lower energy that does not change the physical characteristic of an information recording layer to reproduce information from the optical disk. That is, when recording, a laser diode is driven by a relatively higher writing power to form a pit on the optical disk where information is recorded. Forming a pit to a predetermined length is referred to as a write strategy.

When information is recorded on a recordable optical disk such as a CD-R/RW, an optical disk recording and/or reproducing apparatus performs an optimum power control (OPC) process to determine a write power appropriate to the disk. For this, a recordable optical disk has a power calibration area in a lead-in area of the disk to determine a write power.

A general structure of an optical recording information storage medium according to the conventional technology will now be explained briefly. FIG. 1 is a diagram showing a double-layered information storage medium including two recording layers in which data is recorded using an opposite track path (OTP) method according to the conventional technology.

The information storage medium includes two recording layers L0 and L1. The recording layer L0 includes a lead-in area 10, a data area 11, and a middle area 12, and the recording layer L1 includes a middle area 13, a data area 14, and a lead-out area 15. Information is recorded on the information storage medium shown in FIG. 1 using an opposite track path (OTP) method, progressing from an inner circumference of the recording layer L0 to an outer circumference of the recording layer L0 and continuing on the recording layer L1 from an outer circumference to an inner circumference of the recording layer L1.

FIG. 2 is a diagram showing a double-layered information storage medium including two recording layers in which data are recorded using a parallel track path (PTP) method according to the conventional technology. The information storage medium includes two recording layers L0 and L1. The recording layer L0 includes a lead-in area 10, a data area 11, and a middle area 12. The recording layer L1 includes a middle area 13, a data area 14, and a lead-out area 15. Information is recorded on the information storage medium shown in FIG. 2 using a parallel track path (PTP) method, and data is recorded in an identical direction in both recording layers L0 and L1.

FIG. 3 is a diagram of a disk structure showing a data structure of a lead-in area of an information storage medium according to the conventional technology. Referring to FIG. 3, the information storage medium includes a lead-in area 20 disposed in an inner circumference, a lead-out area 40 disposed in an outer circumference, and a data area 30 disposed between the lead-in area 20 and the lead-out area 40 and in which user data is recorded.

The lead-in area 20 includes a pre-recorded area 21 in which information recorded in advance cannot be changed, and a recordable area 31 in which recorded information can be modified. The pre-recorded area 21 is used as a reproduction dedicated area and includes a control data area 22 in which disk type and version information 23, disk size 24, disk structure 25, recording speed 26, recording parameter 27, etc., are recorded. The recordable area 31 includes a defect management area 33, a test area 34, and a drive/disk state information area 35. A buffer 32 is disposed between the pre-recorded area 21 and the recordable area 31. The defect management area (DMA) 33 is an area in which defect management information is recorded to manage defects occurring in the data area 30. The drive/disk state information area 35 is an area in which state information of a drive or the disk is recorded.

The test area 34 is an area in which test recording is performed in order to find an optimum writing power. The test area 34 is referred to as a power calibration area (PCA). To determine an optimum recording and/or reproducing condition, the characteristics of a recording medium should be measured while varying the recording and/or reproducing condition, which is time consuming. That is, an optimum recording condition is determined by the characteristics of a recording medium and a recording and/or reproducing apparatus. Likewise, a focus position determining a variety of servo operations, optimum servo conditions such as a tracking position, gain, etc., and optimum reproduction signal processing conditions such as equalization characteristics and binarization slice levels are determined by the characteristics of the medium and a recording and/or reproducing apparatus.

Accordingly, whenever a recording and/or reproducing apparatus is activated in order to record data on an optical recording medium placed therein, test recording is performed while varying recording and/or reproducing conditions such as, for example, reproduction processing signal conditions, including a pulse condition, and a servo condition. At this time, a reproduced signal is compared with a predetermined signal in order to determine an optimum recording and/or reproducing condition, and recording information is performed based on the optimum recording and/or reproducing condition. Accordingly, a waiting time is long because the test recording is always performed before recording data on and/or reproducing data from the disk. Also, when a disk has a plurality of recording layers, all optimum recording conditions of each layer should be found in the test area disposed in each of the layers such that the waiting time becomes longer and a user has to wait for a considerable time.

In addition, when only reproducing is performed, for example, even when a write-once disk is finalized or made to prevent recording, there is a need to adjust an equalization frequency or gain or optimum focusing in order to perform optimum reproduction. Accordingly, also in this case, an optimum reproduction condition should be found.

### SUMMARY OF THE INVENTION

An aspect of the present invention provides an optical recording medium, and a recording and/or reproducing method and apparatus by which an optimum recording and/or reproducing condition can be determined quickly in order to minimize a waiting time before recording user data.

An aspect of the present invention provides an optical recording medium, and a recording and/or reproducing method and apparatus by which a reference layer according to an optimum recording and/or reproducing condition is managed in order to record data quickly on a multi-layered information storage medium.

According to an aspect of the present invention, there is provided an optical recording medium formed of a plurality of recording layers, the medium including: a reference signal area disposed in each of the recording layers in order to record a predetermined reference signal at an optimum recording condition determined for optimum recording and/or reproducing operations for each of the recording layers; and a reference signal information area having recorded therein reference signal indicator information which indicates information on one or more recording layers in which the reference signal is recorded among the recording layers.

The reference signal information area may be disposed in a recording layer in which data is recorded first among the recording layers. The reference signal information area may be disposed in a recording layer that is to be a reference layer.

Also, if the optical recording medium is a write-once medium, information for updating the reference signal indicator information recorded in the reference signal information area may be recorded in an unrecorded space of the reference signal information area. The reference signal information area may be disposed in one or more recording layers.

According to another aspect of the present invention, there is provided a method of recording data on an optical recording medium formed of a plurality of recording layers, the method including: recording in one of the recording layers a predetermined reference signal at an optimum recording condition determined for optimum recording and/or reproducing operations in a recording layer in which data is to be recorded among the plurality of recording layers; and recording reference signal indicator information, indicating information on the recording layer in which the reference signal is recorded, in a recording signal information area of the recording layer in which data is first recorded.

According to another aspect of the present invention, there is provided a method of recording data on an optical recording medium formed of a plurality of recording layers, the method including: recording in one of the recording layers a predetermined reference signal at an optimum recording condition determined for optimum recording and/or reproducing operations in a recording layer in which data is to be recorded among the plurality of recording layers; and recording reference signal indicator information, indicating information on the recording layer in which the reference signal is recorded, in a recording signal information area of a recording layer that is to be a reference layer.

Where the optical recording medium is a write-once medium, the method may further include: recording information for updating the reference signal indicator information recorded in the reference signal information area, in an unrecorded space of the reference signal information area.

According to another aspect of the present invention, there is provided a method of reproducing data from an optical recording medium formed of a plurality of recording layers, the method including: reading reference signal indicator information, indicating information on the one or more recording layers in which a reference signal is recorded, from a reference signal area in which a predetermined reference signal is recorded at an optimum recording condition determined for optimum recording and/or reproducing operations for one or more of the recording layers, and determining from the reference signal indicator information, recording layers in which the reference signal is recorded.

According to another aspect of the present invention, there is provided an apparatus for recording data on an optical recording medium formed of a plurality of recording layers, the apparatus including: a writing unit recording data on the medium; and a control unit controlling the writing unit to record a predetermined reference signal in one of the recording layers at an optimum recording condition determined for optimum recording and/or reproducing operations in a recording layer in which data is to be recorded among the plurality of recording layers, and to record reference signal indicator information, indicating information on the recording layer in which the reference signal is recorded, in a recording layer in which data is first recorded.

According to another aspect of the present invention, there is provided an apparatus for recording data on an optical recording medium formed of a plurality of recording layers, the apparatus including: a writing unit recording data on the medium; and a control unit controlling the writing unit to record a predetermined reference signal at an optimum recording condition determined for optimum recording and/or reproducing operations in a recording layer in which data is to be recorded among the plurality of recording layers, in the recording layer, and to record reference signal indicator information, indicating information on the recording layer in which the reference signal is recorded, in a recording layer which is to be a reference recording layer.

According to another aspect of the present invention, there is provided an apparatus for reproducing data from an optical recording medium formed of a plurality of recording layer, the apparatus including: a reading unit reading data from the medium; and a control unit controlling the reading unit to read reference signal indicator information, indicating information on one or more recording layers in which a reference signal is recorded from the medium having a reference signal area in which a predetermined reference signal is recorded at an optimum recording condition determined for optimum recording and/or reproducing operations for one or more of the recording layers, and determining recording layers in which the reference signal is recorded based on the reference signal indicator information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing a double-layered information storage medium formed of two recording layers in which data is recorded in an opposite track path (OTP) method;

FIG. 2 is a diagram showing a double-layered information storage medium formed of two recording layers in which data is recorded in a parallel track path (PTP) method;

FIG. 3 is a diagram of a disk structure showing a data structure of a lead-in area of an information storage medium;

FIG. 4 is a reference diagram for explaining a method of determining an optimum recording and/or reproducing condition of an information storage medium according to an aspect of the present invention;

FIG. 5 illustrates a single-layered information storage medium according to an embodiment of the present invention;

FIG. 6 illustrates a double-layered information storage medium according to an embodiment of the present invention;

FIG. 7 is a block diagram of a structure of a recording and/or reproducing apparatus according to an embodiment of the present invention;

FIG. 8 is a flowchart of the operations performed by a recording and/or reproducing method according to an embodiment of the present invention;

FIG. 9 illustrates a multi-layered information storage medium according to an embodiment of the present invention;

FIG. 10 is a diagram showing a state in which a reference signal is recorded in a reference recording layer (L0) of the multi-layered information storage medium shown in FIG. 9 by a first drive;

FIG. 11 is a diagram showing a state in which a reference signal is recorded in L1 layer of the multi-layered information storage medium shown in FIG. 10 by a second drive;

FIG. 12 illustrates a write-once multi-layered information storage medium according to an embodiment of the present invention;

FIG. 13 is a flowchart for explaining operations of a first drive writing a reference signal on a multi-layered information storage medium and reference signal indicator information in a reference signal information area according to an embodiment of the present invention; and

FIG. 14 is a flowchart for explaining operations of a second drive writing a reference signal and updating a reference signal information area after the operations shown in FIG. 13.

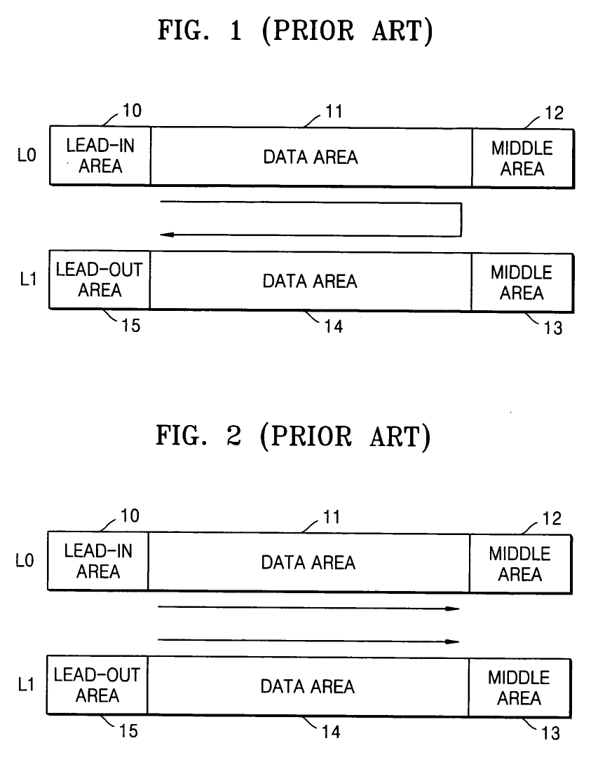

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

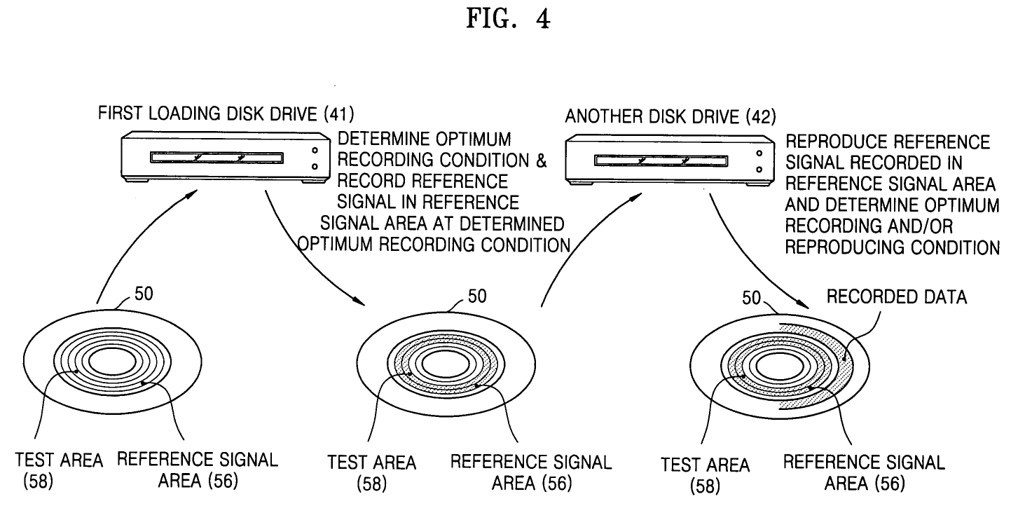

Referring to FIG. 4, an optical disk 50 includes a test area 58 and a reference signal area 56 in a lead-in area.

The test area 58 is an area for a disk drive to test in order to obtain an optimum recording and/or reproducing condition for optimally recording data on or reproducing data from a loaded optical disk. The reference signal area 56 is an area in which predetermined reference data is recorded according to the thus obtained optimum recording condition.

If the optical disk 50 that is to be used for the first time is loaded on the disk drive 41, the disk drive writes data in the test area 58 of the loaded optical disk 50 to test the recording condition and determines an optimum recording and/or reproducing condition. Then, reference data is recorded in the reference signal area 56 disposed on the optical disk 50 at the determined optimum recording condition.

If the optical disk 50 having the reference signal thus recorded in the reference signal area 56 at the optimum recording condition is loaded on another disk drive 42, the another disk drive 42 reproduces the reference signal recorded in the reference signal area 56, determines an optimum recording and/or reproducing condition, and at the determined optimum recording and/or reproducing condition writes data on the optical disk 50 or reproduces data recorded on the optical disk 50.

Thus, if only the disk drive on which an optical disk is first loaded performs the processes including the OPC, finds an optimum recording and/or reproducing condition, and writes a reference signal in a reference signal area of the optical disk at the optimum recording and/or reproducing condition, a disk drive loading the optical disk after the first disk drive does not need to test by writing data in the test area again and reproducing the data in order to determine an optimum recording and/or reproducing condition, and can determine an optimum recording and/or reproducing condition by reproducing the reference signal recorded in the reference signal area at the optimum condition such that the disk drive can save time taken for determining the optimum recording and/or reproducing condition.

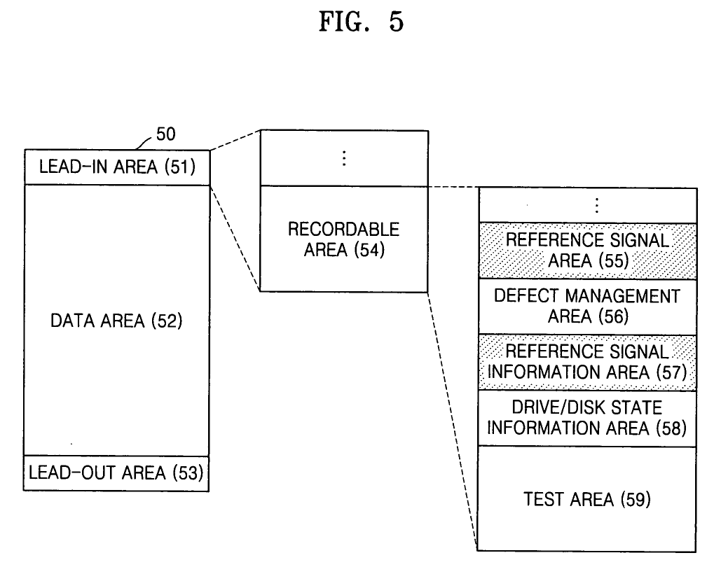

FIG. 5 illustrates a single-layered information storage medium according to an embodiment of the present invention. Referring to FIG. 5, the information storage medium 50 includes a lead-in area 51, a data area 52, and a lead-out area 53. A recordable area 54 of the lead-in area 51 includes a reference signal area 55, a defect management area 56, a reference signal information area 57, a drive/disk state information area 58, and a test area 59.

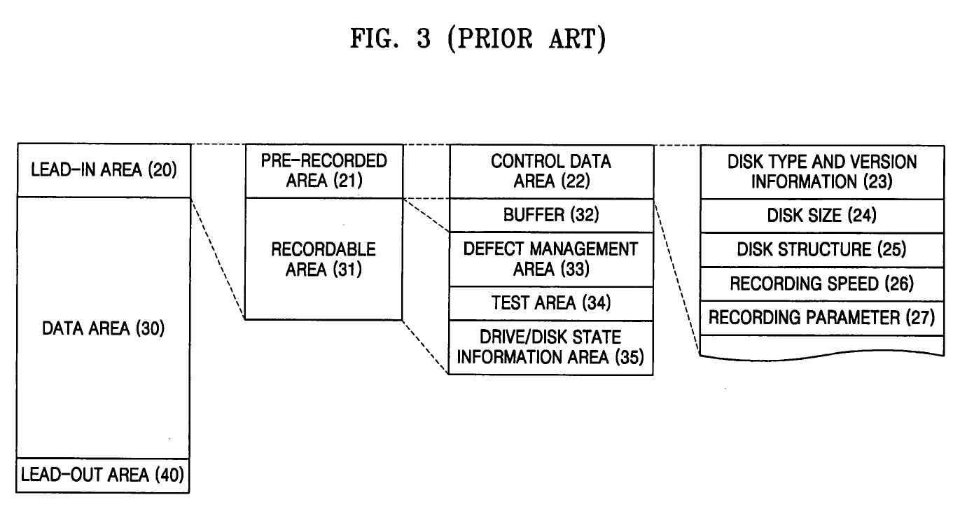

The structure of the information storage medium 50 is similar to that of the conventional disk shown in FIG. 3, but differs in that the reference signal area 55, in which a reference signal is recorded at an optimum recording condition determined by a recording and/or reproducing condition test, and the reference signal information area 57, in which reference signal indicator information indicating the layer in which a reference signal is recorded where a recording medium has a double-layered or a multi-layered structure, are disposed in the recordable area 54 of the lead-in area 51. The reference signal area 55 and the reference signal information area 57 may also be disposed in the lead-out area 53 or a middle area.

A reference signal which is recorded in the reference signal area 56 includes signals useful in setting an equalization condition, a servo condition, a binarization condition, and a pulse condition. The reference signals may be recorded on the single recording layered optical recording medium 50, when the single recording layered optical recording medium 50 is loaded in a disc drive for the first time. The reference signals may satisfy at least one of the following three conditions. First, the reference signals should be recorded on the single recording layered optical recording medium 50 under optimum recording conditions, which are determined through optimum power control (OPC). Second, an amplitude modulation level of the reference signals should be higher than 0.3. Third, the reference signals should have a jitter level lower than 7%. The reference signals may be recorded on the single recording layered optical recording medium satisfying only one of the three conditions. In addition, the second or third condition can be satisfied by appropriately determining optimum recording conditions for the single recording layered optical recording medium.

Here, the reference signals may have a different amplitude modulation level and a different jitter level from those set forth herein, depending on the specifications of the single recording layered optical recording medium. Additionally, the reference signals may be recorded in the reference signal area 55 in a random pattern. However, for a specific purpose, such as measurement of the degree to which the amplitude of the reference signals is modulated, the reference signals may also be recorded in the reference signal area in a unique pattern.

The reference signal information area 57 is an area for recording reference signal indicator information indicating the recording layer in which a reference signal is recorded where the medium is formed of a plurality of layers. Where an information storage medium is formed of a plurality of layers, a drive which first uses this multi-layered information storage medium may test all layers and record a reference signal; or the first drive may test only recording layers that the drive intends to use and record a reference signal, thus reducing the time for recording user data.

If a reference signal is not recorded in each of the plurality of layers, the recording layers in which a reference signal is recorded need to be indicated. Thus, reference signal indicator information indicating in which recording layer a reference signal is recorded is recorded in the reference signal information area 57. In a case of a rewritable medium, since the reference signal indicator information can be updated and recorded in an identical location, the reference signal information area can be disposed in a fixed area. However, in case of a write-once medium, the reference signal indicator information cannot be updated in an identical location and according to the change of the reference signal indicator information, the recording area needs to continuously increase, the reference signal information area may be an expandable area. For example, the reference signal information area may be disposed in a predetermined area of all recording layers, for example, in a lead-in area, a middle area, or a lead-out area.

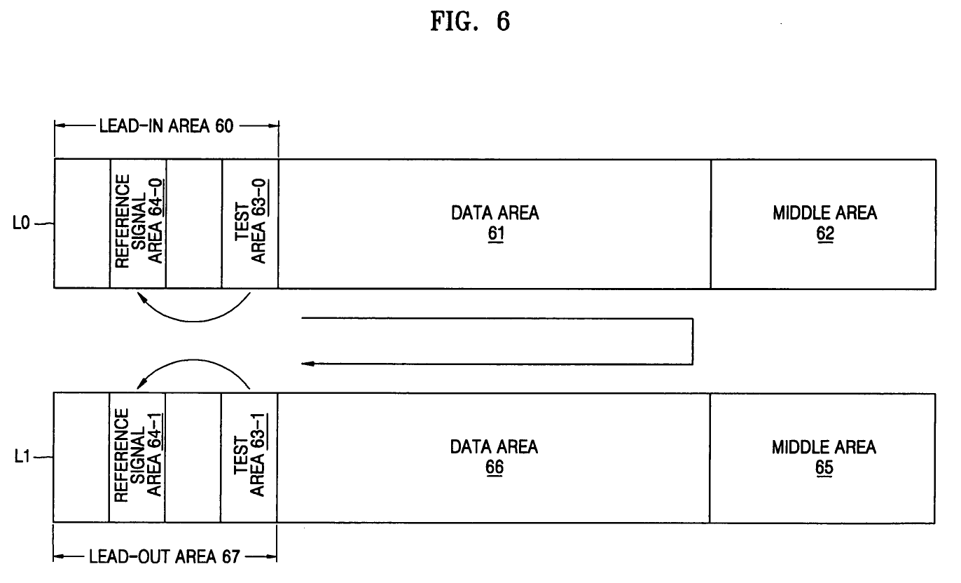

FIG. 6 illustrates a double-layered information storage medium according to an embodiment of the present invention. Where an information storage medium has a plurality of recording layers, an optimum recording and/or reproducing condition is different at each recording layer. Accordingly, the double-layered information storage medium according to an aspect of the present invention has a reference signal area, in which a reference signal is recorded at an optimum recording condition, in each recording layer.

Referring to FIG. 6, the double-layered information storage medium has two recording layers L0 and L1. The recording layer L0 includes a lead-in area 60, a data area 61, and a middle area 62, and the recording layer L1 includes a middle area 65, a data area 66, and a lead-out area 67. The lead-in area 60 includes a test area 63-0 and a reference signal area 64-0 and the lead-out area 67 includes a test area 63-1 and a reference signal area 64-1. If the information storage medium formed of two recording layers is loaded on a recording and/or reproducing apparatus for the first time, the first recording and/or reproducing apparatus performs recording and/or reproducing tests in the test area 63-0 disposed in the lead-in area 60 of the recording layer L0, determines an optimum recording and/or reproducing condition, and records a predetermined reference signal in reference signal area 64-0 at the determined optimum recording condition. Also, the first recording and/or reproducing apparatus performs recording and/or reproducing tests in the test area 63-1 disposed in the lead-out area 67 of the recording layer L1, determines an optimum recording and/or reproducing condition, and records a predetermined reference signal in the reference signal area 64-1 at the determined optimum recording condition.

If the information storage medium, in which a reference signal appropriate to each recording layer is recorded in the reference signal area of the recording layer at an optimum recording condition, is loaded on another recording and/or reproducing apparatus, the another recording and/or reproducing apparatus reproduces a reference signal from the reference signal area disposed in each recording layer and determines an optimum recording and/or reproducing condition appropriate to the recording layer.

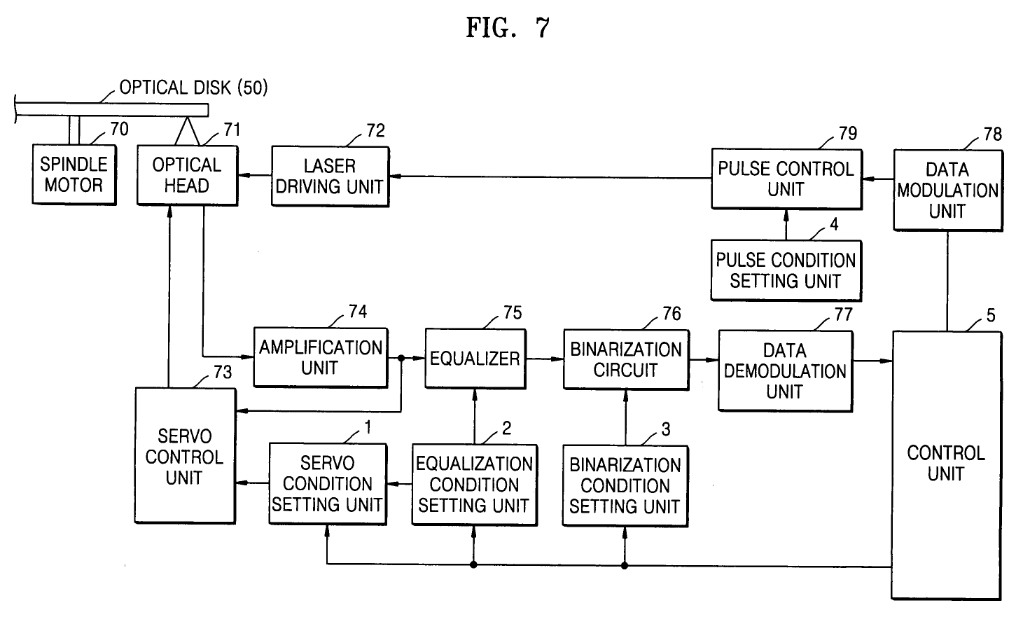

FIG. 7 is a block diagram of a structure of a recording and/or reproducing apparatus according to an embodiment of the present invention. Referring to FIG. 7, the recording and/or reproducing apparatus shown in FIG. 7 includes a spindle motor 70, an optical head 71, a laser driving unit 72, a servo control unit 73, an amplification unit 74, an equalizer 75, a binarization circuit 76, a data demodulation unit 77, a data modulation unit 78, a pulse control unit 79, and a control unit 5, and as an apparatus for setting recording and/or reproducing conditions, a servo condition setting unit 1, an equalization condition setting unit 2, a binarization condition setting unit 3, and a pulse condition setting unit 4.

The spindle motor 70 rotates the optical disk 50 placed on the recording and/or reproducing apparatus. The control unit 5 performs overall control of the recording and/or reproducing apparatus. The data modulation unit 78 converts data to be recorded into a recording signal. The pulse control unit 79 controls a laser pulse according to a pulse condition set by the pulse condition setting unit 4. The laser driving unit 72 drives a laser diode according to the signal from the pulse control unit 79. The optical head 71 focuses a laser beam on the optical disk 50 in order to record information on the optical disk 50 or generate a reproduction signal from a light reflected from the optical disk 50.

The servo control unit 73 controls focusing and tracking of the optical head 71 according to the servo condition based on the signal output from the amplification unit 74. The amplification unit 74 amplifies the reproduction signal output from the optical head 71. The equalizer 75 modifies the frequency characteristic of the reproduction signal output from the amplification unit 74. The binarization circuit 76 converts the signal modified by the equalizer 75 into a binary signal. The data demodulation unit 77 demodulates the data output from the binarization circuit 76.

The servo condition setting unit 1 sets the servo condition at the servo control unit 73. The equalization condition setting unit 2 sets the equalization condition at the equalizer 75. The binarization condition setting unit 3 sets a binarization slice level at the binarization circuit 76. The pulse condition setting unit 4 sets the pulse condition for the time when information is recorded.

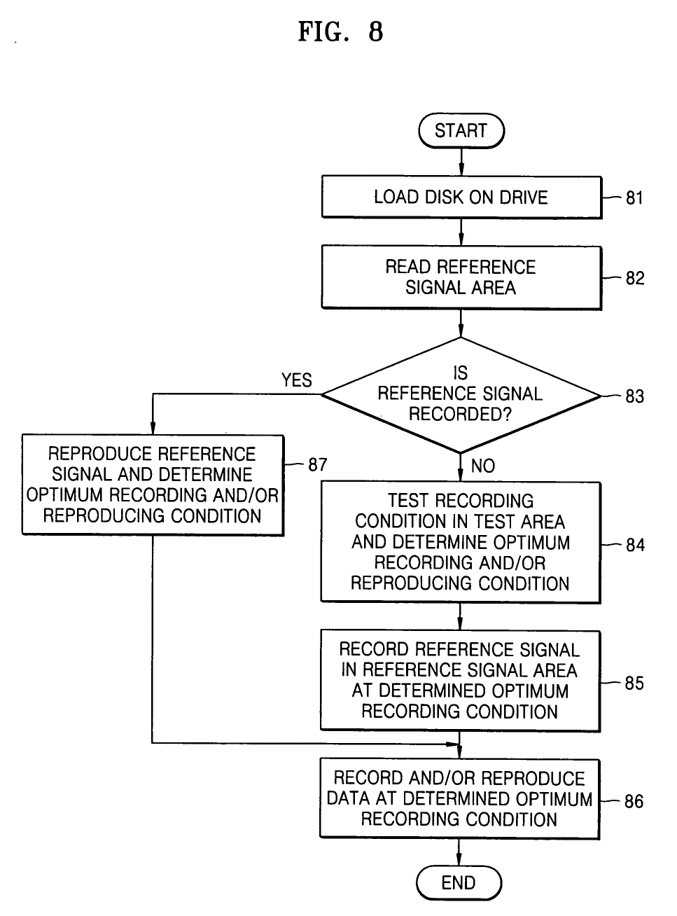

FIG. 8 is a flowchart of a recording and/or reproducing method according to an embodiment of the present invention. Referring to FIG. 8, the optical disk 50 is loaded on a drive in operation 81. Thereafter, the optical disk 50 is rotated by the spindle motor 70. Then, a laser beam to reproduce information is irradiated onto the optical disk 50 by the optical head 71. By accessing the lead-in area of the disk 50, identification and other information of the disk 50 recorded in the lead-in area is read out. In order to read the identification and other information, a reproduction signal obtained by the optical head 71 from the light beam reflected from the disk 50 is amplified and the frequency characteristic of the signal is modified by the equalizer 75 having a preset equalization condition. Next, the signal is binarized by the binarization circuit 76 set to a predetermined binarization slice level. The thus binarized signal is demodulated by the data demodulation unit 77 and then, transmitted to the control unit 5. The servo control unit 73 controls focusing and tracking of the optical head 71 based on the signal output from the amplification unit 74 according to the preset servo condition. By this operation, the disk identification information recorded in the lead-in area of the optical disk 50 is transmitted to the control unit 5.

Next, a reference signal area disposed on the disk 50 is read in operation 82. The reference signal area is an area having a reference signal recorded at an optimum recording condition. In the same manner as the lead-in area is accessed and identification information is read, the reference signal area is accessed and the reference signal is read.

The reference signal area in the disk 50 is accessed and focusing or tracking is controlled by the optical head 71 according to the preset servo condition of the servo control unit 73. The reproduction signal obtained by the optical head 71 from the laser beam reflected from the disk 50 is amplified by the amplification unit 74, and the frequency characteristic is modified by the equalizer 75 having a preset equalization condition. Then, the reproduction signal is binarized by the binarization circuit 76 in which the binarization slice level is preset. The thus binarized signal is demodulated and provided to the control unit 5.

Next, it is determined whether a reference signal is recorded in operation 83. That is, the control unit 5 determines from the provided binarized signal whether or not a reference signal is recorded. If a reference signal is not recorded, a recording condition is tested in a test area disposed in the disk 50 and an optimum recording and/or reproducing condition is determined in operation 84.

First, according to a preset condition or a condition specified by identification information in the disk 50, the pulse condition setting unit 4 sets a pulse condition at the pulse control unit 79, the servo condition setting unit 1 sets a servo condition at the servo control unit 73, the equalization condition setting unit 2 sets an equalization condition at the equalizer 75, and the binarization condition setting unit 3 sets a binarization slice level at the binarization circuit 76.

Then, test data for a predetermined recording test output from the control unit 5 is converted into a recording signal by the modulation unit 78, and the converted recording signal is converted into a laser driving signal satisfying the pulse condition set by the pulse control unit 79. The laser driving unit 72 drives the laser diode of the optical head 71 according to the laser driving signal. The optical head 71 for focusing and tracking is controlled by the servo control unit 73, focuses light irradiated from the laser diode, and forms a mark in the test area of the optical disk to record information.

The reproduction signal of data recorded as a test on the disk 50 is amplified by the amplification unit 74 and then, the frequency characteristic of the signal is corrected by the equalizer 75. Then, the jitter value (position change of the reproduction signal in relation to a reference clock) of the signal binarized by the binarization circuit 76 is measured by the control unit 5 and this value is compared with a preset standard value. If the jitter value satisfies the standard value, the set conditions are determined as an optimum condition. However, if the jitter value does not satisfy the standard value, the pulse condition, the servo condition, the equalization condition, and the binarization slice level are continuously changed, test data is recorded for a test, and the jitter value of the recorded data is measured.

Next, a reference signal is recorded in the reference signal area at the determined optimum recording condition in operation 85. The condition setting unit 4 is set with the thus determined optimum recording condition. That is, the pulse condition setting unit 4 sets the pulse condition according to the optimum recording condition at the pulse control unit 79 the servo condition setting unit 1 sets the servo condition according to the optimum recording condition at the servo control unit 73, the equalization condition setting unit 2 sets the equalization condition according to the optimum recording condition at the equalizer 75, and the binarization condition setting unit 3 sets the binary slice level according to the optimum recording condition at the binarization circuit 76.

The reference data output from the control unit 5 is converted into a recording signal by the modulation unit 78, and the recording signal is converted into a laser driving signal satisfying the pulse condition set by the pulse control unit 79. The recording pattern of the reference data may be a random pattern, and when data is recorded for a special purpose, for example, for a purpose of measuring a modulation degree, a special pattern instead of the random pattern may also be recorded.

According to the laser driving signal, the laser driving unit 72 drives the laser diode disposed in the optical head 71, and forms a mark in the reference signal area of the optical disk 50 such that the reference signal is recorded.

Next, user data is recorded and/or reproduced at the determined optimum recording condition in operation 86. In the same manner as the reference signal is recorded in the reference signal area, as described above, user data is recorded in the data area of the optical disk 50 at the determined optimum recording condition and the recorded data is reproduced at the determined optimum recording condition.

In operation 83, if a reference signal is recorded in the reference signal area, the reference signal is reproduced to determine an optimum recording and/or reproducing condition in operation 87. Since the reference signal to find an optimum recording and/or reproducing condition is already recorded, the optimum recording and/or reproducing condition can be determined by only reproducing the reference signal recorded in the reference signal area. Then, the user data is recorded on and/or reproduced from the disk 50 at the determined optimum recording condition in operation 86.

In a case of a multi-layered information storage medium, a method of recording a reference signal in a first drive that uses the multi-layered information storage medium will now be explained. In this method, where a double-layered information storage medium is loaded for the first time on a drive, a test is performed for both recording layers L0 and L1, and reference signals for the recording layers L0 and L1, respectively, are all recorded at the first drive is explained above with reference to FIG. 6. However, in case of a multi-layered information storage medium, including a double-layered medium, recording reference signals for all layers is not efficient where one layer has sufficient capacity to record the desired data.

That is, after the multi-layered information storage medium is first loaded on the first drive, in order to record reference signals for all layers included in this information storage medium, optimum power control (OPC) for all layers should be performed to find optimum recording conditions and then, the reference signals should be recorded in all recording layers. Accordingly, even when a user records data only in one recording layer, for example, layer 0 nearest to the pickup, in order to record reference signals in all recording layers, the recording time will be longer in accordance with the number of recording layers, and the OPC time will also be longer.

Accordingly, where a multi-layered information storage medium is first loaded on a drive, a reference signal may be tested and recorded only in a recording layer in which data is desired to be recorded, and reference signal indicator information indicating the recording layer in which this reference signal is recorded is recorded in a recording layer to be first used, or in a reference recording layer. The reference recording layer refers to a recording layer which is a reference layer in a plurality of recording layers, and a recording layer which is in a same position as an incident surface in a signal recording layer is referred to as a reference recording layer in a plurality of recording layers. Mostly, this reference recording layer is first used in a drive which uses an information storage medium for the first time, and in a drive having a policy randomly using recording layers, other recording layers than the reference recording layer may also be used first.

The reference signal indicator information may be recorded only in a recording layer that is first used, that is, the reference recording layer. Recording information on which recording layer a reference signal is recorded will be sufficient, if the information is recorded in any one location known to a drive.

Further, if this reference signal indicator information is recorded in all other recording layers, reproducing the reference signal indicator information recorded in other recording layers will be performed after the optimum recording condition is found and recorded in the reference recording layer and therefore, the reproducing will not have any meaning.

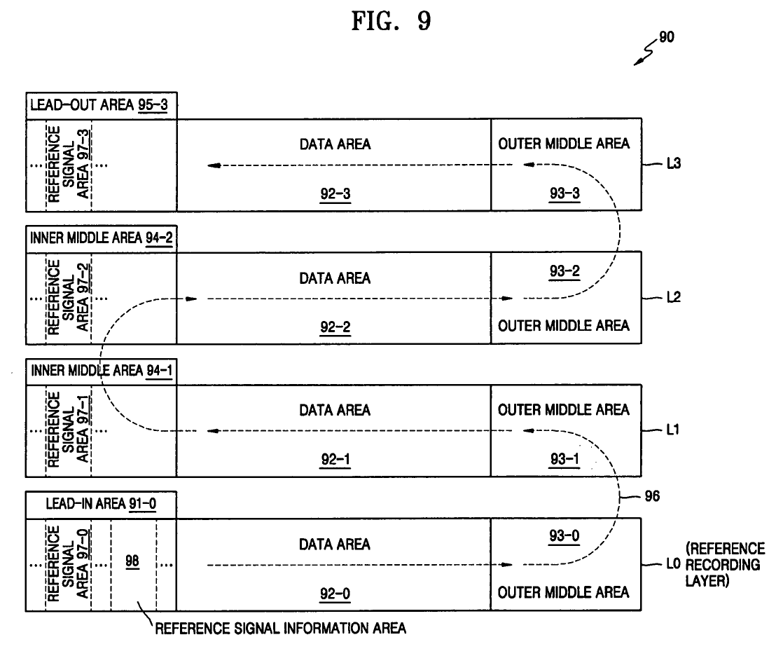

A method of recording a reference signal in this multi-layered information storage medium will now be explained in more detail. FIG. 9 illustrates a rewritable multi-layered information storage medium according to an embodiment of the present invention. Referring to FIG. 9, the multi-layered information storage medium 90 includes 4 layers L0, L1, L2 and L3.

In the layer L0, a lead-in area 91-0, data area 92-0, and an outer middle area 930 are continuously arranged in order. In the layer L1, an inner middle area 94-1, a data area 92-1, and an outer middle area 93-1 are continuously arranged. In the layer L2, an inner middle area 94-2, data area 92-2, and an outer middle area 93-2 are continuously arranged. In the layer L3, a lead-out area 95-3, a data area 92-3, and an outer middle area 93-3 are continuously arranged. The direction of using the medium is an opposite track path (OTP) in which usage directions are opposite in neighboring layers as shown by the arrows 96. In the parallel track path (PTP) in which usage directions are identical in neighboring layers, the arrangements may be identically applied.

In each of the layers L0, L1, L2 and L3, there is disposed a corresponding reference signal area 97-0, 97-1, 97-2 and 97-3, respectively, in which an optimum recording and/or reproducing condition may be found through a test and a reference signal may be recorded according to the condition. More specifically, the reference signal area 97-0 is disposed in the lead-in-area 91-0 in the layer L0, the reference signal area 97-1 is disposed in the inner middle area 94-1 in the layer L1, the reference signal area 97-2 is disposed in the inner middle area 94-2 in the layer L2, and the reference signal area 97-3 is disposed in the lead-out area 95-3 in the layer L3.

Also, in the lead-in area 91-0 of the reference recording layer L0, a reference signal information area 98 is disposed. The reference signal information area 98 is an area in which information, indicating a layer where a reference signal is recorded among layers of the multi-layered information storage medium, is recorded. After the reference signal is recorded in the reference recording layer by the first drive and the reference signal indicator information, indicating that the reference signal is recorded in the reference recording layer, is recorded in the reference signal information area 96, if a reference signal is further recorded in another layer by a second drive, the reference signal indicator information indicating that reference signals are recorded in the reference recording layer and the another layer, is updated in this reference signal information area 98.

Because of the reasons described above, if the reference signal information area 98 is disposed only in the reference recording layer L0, it will be enough. In addition, the reference recording layer has may be a recording layer other than LOwhere the other layer is first used by a drive which uses the disk for the first time.

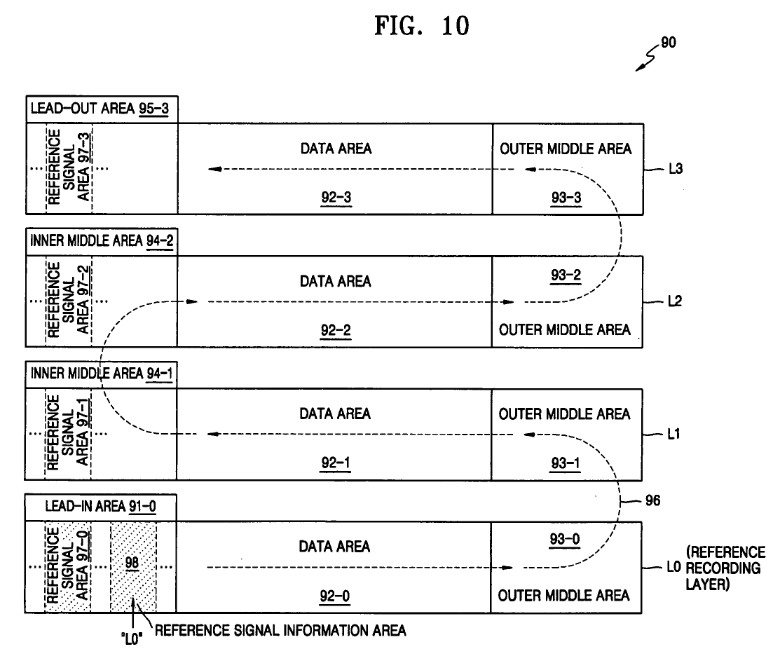

A state in which a reference signal is recorded after a multi-layered information storage medium that has the structure as described above with reference to FIG. 9 and has not been used is loaded on a first drive in order to be used is shown in FIG. 10.

FIG. 10 is a diagram showing a state in which a reference signal is recorded in the reference recording layer L0 of the multi-layered information storage medium 90 shown in FIG. 9 by the first drive. When the multi-layered information storage medium that has not been used is loaded on the first drive, the first drive tests only a recording layer (L0, L1, L2 or L3) in which data is to be recorded and determines an optimum recording and/or reproducing condition. Then, according to the determined condition, the first drive records a reference signal in the reference signal area (97-0, 97-1, 97-2 or 97-3). Referring to FIG. 10, for example, if the first drive determines to record data in the recording layer L0, the first drive tests in a test area (not shown) disposed in the lead-in area 91-0, determines an optimum recording and/or reproducing condition, and according to the determined condition, records the reference signal in reference signal area 97-0. Then, reference signal indicator information (“L0”) indicating that the reference signal is recorded in the recording layer L0 is recorded in the reference signal information area 98 of the lead-in area.

Then, the first drive performs a data recording operation in data area 92-0 of the recording layer L0. After the data recording operation is finished, the first drive performs tests for layers L1, L2 and L3 to find optimum recording and/or reproducing conditions, and then, records reference signals according to these conditions in the reference signal areas 97-1, 97-2 and 97-3 of respective recording layers. Also, information indicating that the reference signals are recorded in the recording layers L0, L1, L2 and L3 may be updated in the reference signal information area 98.

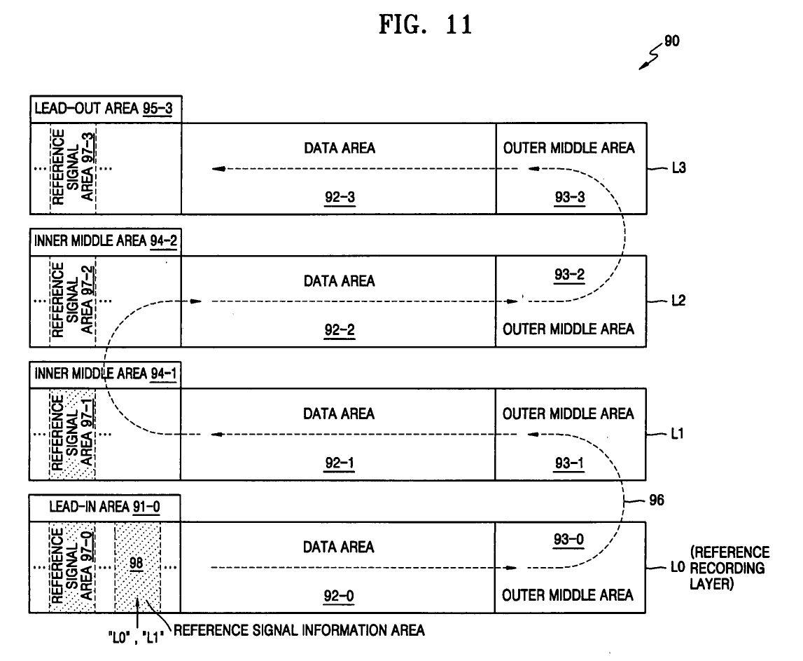

A state in which a reference signal is recorded by a second drive when the multi-layered information storage medium 90 is loaded on the second drive after the data recording operation by the first drive is finished, is shown in FIG. 11. The state shown in FIG. 11 is also applicable where the multi-layered information storage medium is loaded again onto the first drive.

FIG. 11 shows a state in which a reference signal is recorded in the layer L1 of the multi-layered information storage medium 90 shown in FIG. 10 by a second drive. When the multi-layered information storage medium in the state as shown in FIG. 10 is loaded on the second drive, the second drive confirms that a reference signal is recorded only in the layer L0, from the reference signal information area 98 of the lead-in area 97-0 of the reference recording layer L0. If the data area 92-0 of the layer L0 has unused area in which data can be recorded, data is recorded in the data area 92-0 at the recording condition determined with reference to the reference signal recorded in the reference signal area 97-0. However, if there is no space in the data area 92-0 in which to record data, the second drive performs a test in the layer L1 in order to use the layer L1, and at the determined optimum recording and/or reproducing condition, records a reference signal in reference signal area 97-1 disposed in the inner middle area 94-1.

Then, in order to indicate that reference signals are now recorded in the layers L0 and L1, the reference signal indicator information recorded in the reference signal information area 98 is updated to include “L0” and “L1”.

Meanwhile, in case of a rewritable medium, updating data at an identical location can be performed many times. However, in case of a write-once medium, since updating data in an identical location is impossible, the reference signal information area may be disposed at more than one location.

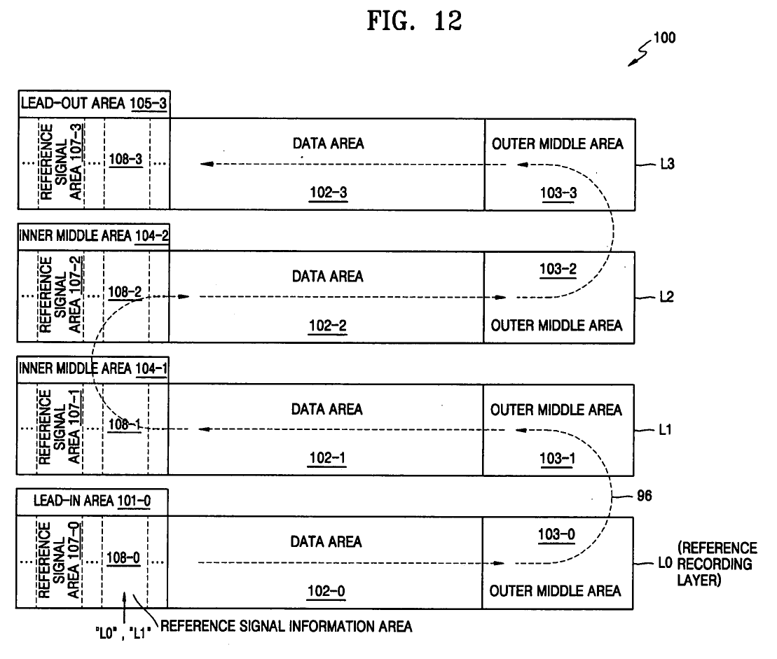

FIG. 12 illustrates a write-once multi-layered information storage medium according to an embodiment of the present invention. Referring to FIG. 12, the write-once multi-layered information storage medium includes 4 layers L0, L1, L2, and L3.

In the layer L0, a lead-in area 101-0, a data area 102-0, and an outer middle area 103-0 are continuously arranged in order In the layer L1, an inner middle area 104-1, a data area 102-1, and an outer middle area 103-1 are continuously arranged. In the layer L2, an inner middle area 104-2, a data area 102-2, and an outer middle area 103-2 are continuously arranged. In the layer L3, a lead-out area 105-3, a data area 102-3, and an outer middle area 103-3 are continuously arranged.

In each of the layers L0, L1, L2 and L3, there is disposed a reference signal area, 107-0, 107-1, 107-2 and 107-3, respectively in which an optimum recording and/or reproducing condition can be found through a test and a reference signal can be recorded according to the condition, and a reference signal information area, 108-0, 108-1, 108-2 and 108-3, respectively, in which reference signal indicator information, indicating in which layer a reference signal is recorded, can be recorded. That is, reference signal area 107-0 and reference signal information area 108-0 are disposed in the lead-in area 101-0 in the layer L0, reference signal area 107-1 and reference signal information area 108-1 are disposed in inner middle area 104-1 in the layer L1, reference signal area 107-2 and reference signal information area 108-2 are disposed in inner middle area 104-2 in the layer L2, and reference signal area 107-3 and reference signal information area 108-3 are disposed in the lead-out area 105-3 in the layer L3.

Unlike a rewritable medium, in the write-once recording medium, reference signal indicator information that is recorded in a reference signal information area is not updated in an identical location but is updated in a next location, and with changes in the reference signal indicator information, the area required to record the reference signal indicator information increases according to a number of times which the reference signal information is recorded. Accordingly, in case of a write-once medium, as shown in FIG. 12, the reference signal information area may disposed in more than one location or in all the recording layers.

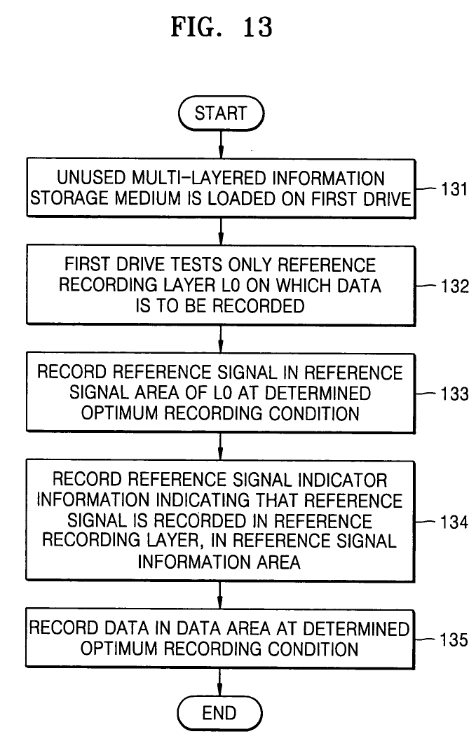

FIG. 13 is a flowchart for explaining operations of a first drive writing a reference signal on a multi-layered information storage medium and reference signal indicator information in a reference signal information area according to the present invention. An unused multi-layered information storage medium is loaded on the first drive in operation 131. The control unit of the first drive tests only a layer (reference recording layer L0) in which data is to be recorded in operation 132, and controls a writing/reading unit so that a reference signal is recorded in the reference signal area of L0 at the determined optimum recording condition in operation 133.

Then, the control unit of the first drive controls the writing/reading unit such that reference signal indicator information, indicating that the reference signal is recorded in reference recording layer L0, is recorded in the reference signal information area disposed in the lead-in area of the medium in operation 134. Next, the writing/reading unit of the first drive records data in the data area of L0 at the determined optimum recording condition in operation 135.

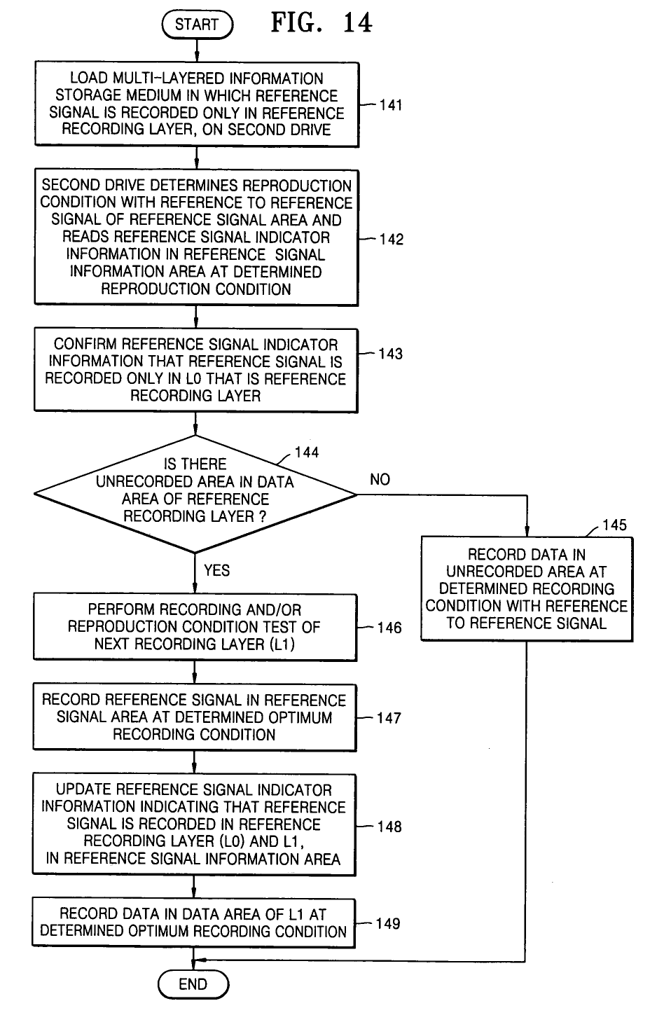

FIG. 14 is a flowchart for explaining operations of a second drive writing a reference signal and updating a reference signal information area after the operations shown in FIG. 13. The multi-layered information storage medium in which the reference signal is recorded only in the reference recording layer is loaded on the second drive in operation 141. The control unit of the second drive determines a reproduction condition with reference to the reference signal of the reference signal area of the recording layer L0, and controls the writing/reading unit so that the reference signal indicator information in the reference signal information area is read at the determined reproduction condition in operation 142.

The control unit of the second drive confirms the reference signal indicator information that the reference signal is recorded only in L0 layer that is the reference recording layer in operation 143. Then, the control unit confirms whether there is an unrecorded area in the data area of the reference recording layer in operation 144. If there is an unrecorded area in the reference recording layer according to the confirmation result of the control unit, the writing/reading unit records data in the unrecorded area at the determined recording condition with reference to the reference signal in operation 145.

If there is no unrecorded area in the reference recording layer according to the confirmation result of the control unit, the control unit performs a writing and/or reproducing condition test for a next recording layer (L1) in order to use the recording layer (L1) in operation 146. The control unit controls the writing/reading unit such that a reference signal is recorded in a reference signal area at the determined optimum recording condition in operation 147.

Also, the control unit controls the writing/reading unit such that reference signal indicator information indicating that the reference signals are recorded in the reference recording layers L0 and L1 is updated in the reference signal information area in operation 148. At this time, in case of a write-once medium, reference signal indicator information is recorded in a location next to the location where the first reference signal indicator information is recorded, in the reference signal area.

Also, if data is recorded in all the reference signal information area disposed in L0 and there is no more space for recording data, updated reference signal indicator information is recorded in a reference signal information area disposed in the lead-in area of a recording layer to be used next, for example, the recording layer L1. Then, the control unit controls the writing/reading unit such that data is recorded in the data area of the recording layer L1 at the determined optimum recording condition in operation 149.

According to aspects of the present invention as described above, by recording a signal that is to be a reference signal, at a predetermined location of at least one of a lead-in area and a lead-out area of an optical information storage medium, even if the thus recorded disk is loaded on another disk drive, an additional OPC does not need to be performed and, by using the reference signal, an optimum recording and/or reproducing condition can be quickly set.

Also, even when only reproducing data is performed, by using the reference signal recorded on the disk, equalizer gain and frequency adjustment, or optimum focusing adjustment can be performed.

Further, in case of a multi-layered information storage medium, the reference signal is not recorded in all layers, but by recording the reference signal only in layers that are to be used by a first drive, data can be recorded at a minimum time when the disk is first used, and by making a mark on a recording layer in which a reference signal is recorded, management of the reference signal can be performed efficiently.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical recording medium formed of a plurality of recording layers, comprising:
a reference signal area disposed in each of the recording layers to record a predetermined reference signal at an optimum recording condition determined for optimum recording and/or reproducing operations for each respective recording layer; and
a reference signal information area having recorded therein reference signal indicator information which indicates information on at least one of the recording layers in which the reference signal is recorded among the recording layers.

2. The recording medium of claim 1, wherein the reference signal information area is disposed in a recording layer in which data is recorded first among the plurality of recording layers.

3. The recording medium of claim 1, wherein the reference signal information area is disposed in a recording layer that is to be a reference layer.

4. The recording medium of claim 1, wherein if the optical recording medium is a write-once medium, information for updating the reference signal indicator information recorded in the reference signal information area is recorded in an unrecorded space of the reference signal information area.

5. The recording medium of claim 4, wherein the reference signal information area is disposed in at least one of the recording layers.

6. A method of recording data on an optical recording medium formed of a plurality of recording layers, the method comprising:
recording in one of the recording layers a predetermined reference signal at an optimum recording condition determined for optimum recording and/or reproducing operations in a recording layer in which data is to be recorded among the plurality of recording layers; and
recording reference signal indicator information, indicating information on the recording layer in which the reference signal is recorded, in a recording signal information area of the recording layer in which data is first recorded.

7. A method of recording data on an optical recording medium formed of a plurality of recording layers, the method comprising:
recording in one of the recording layers a predetermined reference signal at an optimum recording condition determined for optimum recording and/or reproducing operations in a recording layer in which data is to be recorded among the plurality of recording layers; and
recording reference signal indicator information, indicating information on the recording layer in which the reference signal is recorded, in a recording signal information area of a recording layer that is to be a reference.

8. The method of claim 6, wherein if the optical recording medium is a write-once medium, the method further comprises recording information for updating the reference signal indicator information recorded in the reference signal information area in an unrecorded space of the reference signal information area.

9. The method of claim 8, wherein if there is no space to record the reference signal indicator information in the recording layer in which the data is first recorded, the method further comprises recording the reference signal indicator information in a reference signal information area of another one of the recording layers.

10. A method of reproducing data from an optical recording medium formed of a plurality of recording layers, the method comprising:
reading reference signal indicator information from at least one layer of the optical recording medium, the reference signal information indicating information on each recording layer in which a reference signal is recorded at an optimum recording condition; and
determining from the reference signal indicator information, recording layers in which the reference signal is recorded.

11. The method of claim 10, wherein the reading of the reference signal indicator information comprises reading the reference signal indicator information from one of the recording layers in which data is to be recorded first.

12. The method of claim 10, wherein the reading of the reference signal indicator information comprises reading the reference signal indicator information from a reference recording layer among the plurality of recording layers.

13. The method of claim 10, wherein if the optical recording medium is a write-once medium, the reading of the reference signal indicator information comprises reading the reference signal indicator information from a recording layer among the plurality of recording layers in which the reference signal indicator information is last recorded.

14. An apparatus for recording data on an optical recording medium formed of a plurality of recording layers, the apparatus comprising:
a writing unit recording data on the medium; and
a control unit controlling the writing unit to record a predetermined reference signal in one of the plurality of recording layers at an optimum recording condition determined for optimum recording and/or reproducing operations, and to record reference signal indicator information, indicating information on the one of the plurality of recording layers in which the reference signal is recorded, wherein the one of the plurality of recording layers is a first layer to be recorded i.

15. An apparatus for recording data on an optical recording medium formed of a plurality of recording layers, the apparatus comprising:
a writing unit recording data on the medium; and
a control unit controlling the writing unit to record a predetermined reference signal in a reference recording layer among the plurality of recording layers at an optimum recording condition, and to record reference signal indicator information, indicating information on the reference recording layer.

16. The apparatus of claim 14, wherein:
the reference signal information is recorded in a reference signal information area of the optical recording medium, and
if the optical recording medium is a write-once medium, the control unit further controls the writing unit to record information for updating the reference signal indicator information in an unrecorded space of the reference signal information area.

17. The apparatus of claim 14, wherein if there is no space to record the reference signal indicator information in the reference recording layer, the control unit controls the writing unit to record the reference signal indicator information in another one of the plurality of recording layers.

18. An apparatus for reproducing data from an optical recording medium formed of a plurality of recording layers, the apparatus comprising:
a reading unit reading data from the medium; and
a control unit controlling the reading unit to read reference signal indicator information from the recording medium, the reference signal information indicating information on each recording layer in which a reference signal is recorded in a reference signal area at an optimum recording condition determined for optimum recording and/or reproducing operations for one or more of the recording layers, and determining, from the reference signal indicator information, recording layers in which the reference signal is recorded.

19. The apparatus of claim 18, wherein the control unit further controls the reading unit to read the reference signal indicator information from the recording layer among the plurality of recording layers in which data is to be recorded first.

20. The apparatus of claim 18, wherein the control unit further controls the reading unit to read the reference signal indicator information from a reference recording layer among the plurality of recording layers.

21. The apparatus of claim 18, wherein the control unit further controls the reading unit to read the reference signal indicator information from the recording layer among the plurality of recording layers in which updated reference signal indicator information is last recorded.

22. An optical recording medium, comprising:
a plurality of recording layers;
a test area;
a reference signal area recording reference data based on conditions determined by a test recording in the test area using optimum power control; and
a reference signal information area indicating a location of the reference data.

23. The optical recording medium of claim 22, wherein the reference data comprises set-up data useable by a recording and/or a reproducing apparatus.

24. The optical recording medium of claim 23, wherein the set-up data comprises data for setting an equalization condition, data for setting a servo condition, data for setting a binarization condition or data for setting a pulse condition.

25. The optical recording medium of claim 22, wherein each layer comprises a test area, a reference signal area and a reference signal information area.

26. An apparatus for recording and reproducing data on an optical recording medium having a plurality of recording layers, the apparatus comprising:
a laser driving unit writing data to the recording medium and reading data from the recording data on the medium; and
a control unit controlling the writing unit to:
perform a test recording in a test area of one of the layers to determine optimum recording or reproducing conditions using optimum power control;
record reference data in a reference signal area of the one recording layer using the determined optimum conditions; and
record reference signal information in a reference signal information area indicating a location of the reference data.

27. The apparatus of claim 26, wherein the reference data comprises set-up data useable by the recording and reproducing apparatus.

28. The apparatus of claim 27, wherein the set-up data comprises data for setting an equalization condition, data for setting a servo condition, data for setting a binarization condition or data for setting a pulse condition.

29. The apparatus of claim 26, wherein each layer comprises a respective test area, a respective reference signal area and a respective reference signal information area.

30. The apparatus of claim 26, wherein the reference signal area and the reference signal information area are in a same layer.

31. The apparatus of claim 27, wherein the set-up data is useable by another recording apparatus, another reproducing apparatus or another recording and reproducing apparatus.

32. An optical recording medium, comprising:
a plurality of recording layers;
a reference signal area recording a reference signal at an optimum recording condition determined by using optimum power control; and
a reference signal information area indicating information about the reference signal.

33. The method of claim 6, wherein if the optical recording medium is a write-once medium and the reference signal information is to be updated, the method further comprises recording the updated reference signal information in an alternate location.

34. The method of claim 33, wherein the alternate location is alternate location is next to a location where the reference signal information was previously recorded.

35. The method of claim 10, further comprising:
using the reference signal to set parameters for a subsequent recording and/or reproducing session.

36. The method of claim 35, wherein the subsequent recording session is performed using a same recording and/or reproducing apparatus.

37. The method of claim 35, wherein the subsequent recording and/or reproducing session is performed using a different recording and/or reproducing apparatus.

38. The method of claim 36, further comprising:
using the reference signal to set equalizer gain, frequency adjustment or optimum focusing adjustment.

39. The method of claim 6, wherein:
wherein the recording medium is used first used for recording by a first apparatus, the reference signal and the reference signal information are recorded by the first apparatus only in ones of the plurality of layers in which the first apparatus records data.

40. The method of claim 39, wherein:
where the reference signal and the reference signal information have been recorded by the first apparatus in selected ones of the plurality of layers and the recording medium is subsequently in a second apparatus, the second apparatus performs recording and/or reproduction on layers among the plurality of layers having the reference signal recorded by the first apparatus according to the reference signal and the reference signal information recorded by the first apparatus.

41. The method of claim 39, wherein:
where a respective reference signal has not been recorded by the first apparatus in a selected one of the plurality of layers and the recording medium is subsequently used in a second apparatus to record data, the method further comprises:
recording the respective reference signal at an optimum recording condition determined for optimum recording and/or reproducing operations in the selected one of the plurality of layers in which data is to be recorded by the second apparatus; and
updating the reference signal information recorded by the first apparatus to indicate that data has been recorded in the previously unrecorded layer.

42. The method of claim 39, wherein:
where a respective reference signal has not been recorded by the first apparatus in a selected one of the plurality of layers and the recording medium is subsequently used in a second apparatus to record data, the method further comprises:
recording the respective reference signal at an optimum recording condition determined for optimum recording and/or reproducing operations in the selected one of the plurality of layers in which data is to be recorded by the second apparatus; and
recording respective reference signal information in the selected one of the plurality of layers to indicate that data has been recorded in the selected one of the plurality of layers.
